(19) United States
(12) Patent Application Publication
(10) Pub. No.: US 2008/0076851 A1
(43) Pub. Date: Mar. 27, 2008

(54) Hydrophilic surface modification of contact lenses

(76) Inventors: Eugene P. Goldberg, Mt. Dora, FL (US); Khalid Mentak, San Ramon, CA (US); Daniel Urbaniak, Aliso Viejo, CA (US); Amin Elachchabi, Hamden, CT (US)

Correspondence Address: MILES & STOCKBRIDGE PC, 1751 PINNACLE DRIVE, SUITE 500, MCLEAN, VA, 22102-3833, US

(21) Appl. No.: 11/892,965

(22) Filed: Aug. 28, 2007

Related U.S. Application Data
(60) Provisional application No. 60/840,469, filed on Aug. 28, 2006.

(51) Int. Cl. C08J 3/28; G02B 1/04

(52) U.S. Cl. 523/106

(57) ABSTRACT

An improved method for modifying the surface of an article, the surface adapted for contact with living tissue of a human or non-human animal, by the gamma- or electron beam-irradiation induced polymerized, chemically grafted coating thereon of a hydrophilic monomer to form a hydrophilic graft polymer coating of the polymerized monomer or mixture of monomers, the improvement comprising conducting the gamma- or electron beam-irradiation induced graft polymerization in an aqueous solution containing a hydrophilic polymer under conditions whereby the hydrophilic polymer is at least partially entrapped in the graft polymerized coating.

### FIELD OF THE INVENTION

The present invention relates to contact lenses and the like and methods for improving the surfaces thereof.

### BACKGROUND OF THE INVENTION

At the present time, contact lenses (CL) and the like which are intended for contact with sensitive tissue surfaces are constructed of materials having the necessary physical properties to enable their use for the intended application such as extended wear CLs; however, they suffer from the disadvantage that due to the generally hydrophobic nature of tissue contacting surfaces thereof, they exhibit undesired properties and significant damage may occur to fragile or sensitive tissues by adhesion and manipulation or movement on contact with the CLs.

A variety of different types of processes for preparing hydrophilic polymeric coatings on an “inert” hydrophobic substrate have been disclosed in the prior art. For example, surface treatments with various oxidizing agents and primers prior to applying a hydrophilic coating have been described in the literature.

In contact lens (CL) manufacture, plasma treatment has been used to render the surface wettable, more lubricious, and the lens more comfortable to wear. However, a plasma treatment as part of high volume production requires a considerable investment in equipment and is difficult to integrate into automated production processes. For example, a batch process plasma treatment requires high vacuum conditions and the CL must be dried before exposure to the plasma. Thus, polymeric article such as a CL that is wet from prior hydration or purification by solvent extraction must be dried˜thereby adding time and equipment expense in the overall lens production process. In addition, drying a hydrogel type contact lenses often affects the shape and optical quality in an irreversible manner and may create superficial cracks. Therefore, it would be highly desirable to covalently bind of a stable hydrophilic layer to an “inert” surface by a process that avoids plasma treatment.

In U.S. Pats. Nos. 4,806,382; 4,961,954; 5,094,876; 5,100,689; 5,108,776; 4,876; 5,290,548; 5,376,400; 5,885,566; 6,387,379; 5,804,263 and 5,698,192, there are described improved methods for producing hydrophilic, gamma- or electron beam-irradiation induced polymerized and chemically grafted coatings on instruments, devices such as contact lenses and the like so constructed of a variety of polymeric materials.

The invention described in the above-noted patents is predicated on the discovery of certain process conditions and parameters that produce thin, hydrophilic, gamma-irradiation polymerized and chemically grafted coatings of N-vinylpyrrolidone (NVP), copolymerized NVP and 2-hydroxyethyl-methacrylate (HEMA), (NVP-HEMA) or HEMA-PHEMA) on the surfaces of articles adapted for contact with living tissue of a human or non-human animal, e.g., surgical instruments, medical devices, prosthetic implants, contact lenses and the like constructed of a wide variety of plastic materials.

It is an object of the present invention to provide improved contact lenses as well as improved methods for treating contact lenses to enhance the lubricity of the surfaces thereof and improve the overall biocompatibility thereof.

### SUMMARY OF THE INVENTION

One embodiment of the invention relates to an improved method for modifying a plastic surface of an article, the surface adapted for contact with living tissue of a human or non-human animal, by the gamma- or electron beam-irradiation induced polymerized, chemically grafted coating thereon of a hydrophilic monomer such as N-vinylpyrrolidone (NVP), 2-hydroxyethylmethacrylate (HEMA), dimethylacrylamide (DMA) and the like as well as mixtures thereof with each other or with up to about 50 wt. %, based on the total monomer weight, of an ionic monomer, salt of an ionic monomer or mixture thereof, so as to form a hydrophilic graft polymer coating of the polymerized monomer or mixture of monomers, the improvement comprising conducting the gamma-irradiation induced graft polymerization in an aqueous solution also containing a hydrophilic polymer.

Another embodiment of the invention relates to articles of manufacture prepared according to the above-described method.

### DETAILED DESCRIPTION OF THE INVENTION

The present invention is predicated on the discovery that the inclusion of pre-polymerized hydrophilic polymers in the monomer or monomer/mixture subjected to high energy radiation induced graft polymerization on surfaces of articles designed for contact with tissue such as contact lenses, for example, results in the production of surfaces wherein the pre-polymerized polymer is entrapped or enmeshed in the graft coating as it forms, resulting in surfaces with enhanced lubricity and improved biocompatibility than similar methods carried out on the absence of such polymers. The invention described here for CL surface treatment is therefore a technique which is easy to perform with standard equipment under ambient conditions, and which is thus more feasible for an automated production process.

As noted above, hydrophilic surface modification using high-energy radiation has been described in the prior art. The object of this invention is to provide an improved process for hydrophilic surface modification using high energy radiation suitable for contact lens modification that may be easily integrated into high speed automated CL manufacturing. Additionally, the high-energy irradiation step could allow simultaneous surface grafting and sterilization.

Contact lenses of any type may be surface modified according to the method of the invention, including silicone copolymers, hydrogels and RGPs; both Disposable Hydrogel CLs and Extended Wear CLs. Various hydrophilic polymers and monomers may be used in the method of the invention. For example, PVP (Plasdone K-90, C30, C15, and C 10), Gamma polymerized PVP, PHEMA, etc. Monomers employable in the practice of the invention include NVP, HEMA dimethylacrylamide CDMA), and the like. It is a critical feature of the invention that mixtures of monomers and polymers are used.

The term “hydrophilic polymer” as used herein refers to a synthetic polymer composed of molecular segments that render the polymer as a whole “hydrophilic” or naturally occurring polymeric materials that are hydrophilic. As utilized herein, the term “biocompatible polymer” is used to refer to any polymer that is susceptible to implantation in a host (e.g., human host) and does not elicit any adverse reactions.

Preferred synthetic polymers are highly pure or are purified to a highly pure state such that the polymer is biocompatible. Hydrophilic polymers useful herein include, but are not limited to homo-, co-, terpolymers or polymers comprising a polymer backbone that comprises polar heteroatoms (i.e., wherein the polar heteroatoms present within the polymer backbone of the hydrophilic polymers include, but are not limited to, oxygen, nitrogen, sulfur, or phosphorous), such as: polyalkylene oxides, particularly polyethylene glycol, polyethylene oxide, and poly(ethylene oxide)-poly(propylene oxide) copolymers, including block and random copolymers; polyols such as glycerol, polyglycerol (particularly highly branched polyglycerol), propylene glycol and trimethylene glycol substituted with one or more polyalkylene oxides, e.g., mono-, di- and tri-polyoxyethylated glycerol, mono- and di-polyoxyethylated propylene glycol, and mono- and di-polyoxyethylated trimethylene glycol; polyoxyethylated sorbitol, polyoxyethylated glucose; acrylic acid polymers and analogs and copolymers thereof, such as polyacrylic acid per se, polymethacrylic acid, poly(hydroxyethylmethacrylate), poly(hydroxyethylacrylate), poly(methylalkylsulfoxide methacrylate), poly(methylalkylsulfoxide acrylate) and copolymers of any of the foregoing with additional acrylate species such as aminoethyl acrylate and mono-2-(acryloxy)-ethyl succinate; polymaleic acid; poly(acrylamides) such as polyacrylamide per se, poly(methacrylamide), poly(dimethylacrylamide), polydimethylaminoethyl methacrylate, polydimethylaminopropyl methacrylamide, poly(acrylamide/dimethylaminoethyl methacrylate), poly(methacrylic acid/dimethylaminoethyl methacrylate), poly(acrylamide/dimethylaminopropyl methacrylamide), poly(2-acrylamido-2-methyl propane sulfonic acid/dimethylaminoethyl methacrylate), poly (acrylic acid/dimethylaminopropyl methacrylamide), poly(methacrylic acid/dimethylaminopropyl methacrylamide); poly(N-isopropyl-acrylamide); poly(olefinic alcohol)s such as poly(vinyl alcohol); poly(N-vinyl lactams) such as poly(vinyl pyrrolidone), poly(N-vinyl caprolactam), and copolymers thereof; polyoxazolines, including poly(methyloxazoline) and poly(ethyloxazoline); polyvinylamines; polyethylene glycol, polypropylene glycol, branched polyethylene imine, polyvinyl pyrrolidone, polylactide, poly(lactide-co-glycolide), polysorbate, polyethylene oxide, poly(ethylene oxide-co-propylene oxide), poly(oxyethylated) glycerol, poly(oxyethylated) sorbitol, poly(oxyethylated glucose), polymethyloxazoline, polyethyloxazoline, polyhydroxyethyloxazoline, polyhydroxypropyloxazoline, polyvinyl alcohol, poly(hydroxyalkylcarboxylic acid), polyhydroxyethyl acrylic acid, polyhydroxypropyl methacrylic acid, polyhydroxyvalerate, polyhydroxybutyrate, polyoxazolidine, polyaspartamide, polysialic acid, polyalkylene oxide, polyalkyleneimine, polyalkylene amine, polyalkene sulfide, polyalkylene sulfonate, polyalkylene sulfone, poly(alkylenesulfonylalkyleneimine); celluloses; polyamides; polyetheramines; polyethyleneimines; polyhydroxyetheramines; polylysines; polysulfones; gums; starches; cationic starches (formed by reacting a starch, such as corn, maize, waxy maize, potato, tapioca, and the like, with the reaction product of epichlorohydrin and trialkylamine) and derivatives, mixtures and copolymers thereof.

Suitable biocompatible hydrophilic monomers for use in the practice of the invention include ethylenically unsaturated C₃-C₆ carboxylic acids, such as acrylic acid, alkyl acrylic acids (particularly methacrylic acid), itaconic acid, maleic acid, fumaric acid, acrylamidomethyl-propanesulfonic acid, vinyl sulfonic acid, vinyl phosphonic acid, vinyllactic acid, and styrene sulfonic acid; allylamine and allylamine salts formed with an inorganic acid, e.g., hydrochloric acid; di-C₁-C₃-alkylamino-C₂-C₆-alkyl acrylates and methacrylates such dimethylaminoethyl acrylate, dimethylaminoethyl methacrylate, diethylaminoethyl acrylate, diethylaminoethyl methacrylate, dimethylaminopropyl acrylate, dimethylaminobutyl acrylate, dimethylaminoneopentyl acrylate and dimethylaminoneopentyl methacrylate; olefinically unsaturated nitriles, such as acrylonitrile; diolefinically unsaturated monomers, particularly diallylammonium compounds such as dimethyldiallylammonium chloride, dimethyldiallylammonium bromide, diethyldiallylammonium chloride, methyl-t-butyldiallylammonium methosulfate, methyl-n-propyldiallylammonium chloride, dimethyldiallylammonium hydrogensulfate, dimethyldiallylammonium dihydrogenphosphate, di-n-butyldiallylammonium bromide, diallylpiperidinium bromide, diallylpyrrolidinium chloride and diallylmorpholinium bromide; N-vinylpyrrolidone; N-vinylformamide; acrylamide and substituted acrylamides, such as N-methylolacrylamide and C₁-C₃ alkyl acrylamides, particularly methacrylamide; N-vinylimidazole and N-vinylimidazoline; and other monomers, typically ethylenically unsaturated monomers, preferably vinyl monomers, substituted with at least one hydrophilic functionality such as a carboxylate, a thiocarboxylate, an amide, an imide, a hydrazine, a sulfonate, a sulfoxide, a sulfone, a sulfite, a phosphate, a phosphonate, a phosphonium, an alcohol, a thiol, a nitrate, an amine, an ammonium, or an alkyl ammonium group —[NHR¹R²]⁺, wherein R¹ and R² are alkyl substituents and the group is associated with a negatively charged anion, e.g., a halogen ion, nitrate, etc; carboxymethyl cellulose (CMC), hyaluronic Acid (HA) and mixtures thereof.

It will be understood by those skilled in the art that any of the high energy graft polymerization methods described in the patents listed above may be utilized in the practice of the invention. The grafting procedure may include methods in which the grafting solution has an osmolarity similar to that of normal saline, i.e. iso-osmolar, to allow the contact lenses to remain in the grafting solution after irradiation prior to use. The following are typical descriptions of procedures for representative embodiments of this invention:

### EXAMPLE 1

Silicone copolymer contact lenses were placed in tubes containing 10 ml of a deionized water (DI) solution of polyvinylpyrrolidone (PVP/K-90) and N-vinylpyrrolidone (NVP) in a w/w ratio of 4:1 and a total concentration of 10 wt %. Tubes were placed in a carousel holder that rotated around a gamma source at a distance of ˜4″ and samples were irradiated to a total dose of 0.1 Mrad at a dose rate of ˜480 rads/min. The CLs were washed in DI water. They were highly hydrophilic (contact angle ˜20°), more lubricious to the touch and the hydrophilic gamma graft coating was stable to repeated dry-wet cycling.

### EXAMPLE 2

The process of Example 1 was carried out under:

1] Conditions in which the aqueous solution was 2% KOH or NaOH and therefore at a high pH;

2] Conditions in which the polymer-monomer mix ratio is varied from 1:4 to >4:1 and the total solution concentration is varied from 1% to 25%;

3] Conditions in which the polymer in the polymer-monomer mix is carboxymethyl cellulose (CMC), hyaluronic Acid (HA), PDMA, polymethacrylic acid (PMAA), PEG, and other hydrophilic, bioacceptable water soluble natural or synthetic polymers;

4] Conditions in which other hydrophilic or hydrophobic CL materials are substrates;

5] Conditions under which a beneficial ophthalmic drug is incorporated into the graft coating, either during the graft process or after, to afford bioactivity, e.g., an antibiotic, antiinflammatory, and antiglaucoma agents;

6] Conditions under which grafting is achieved simultaneously with radiation sterilization at total dosed up to 5Mrad, all with results similar to those produced in Example 1.

The contact lenses and other optical devices which may be modified according to the method of the invention may be constructed according to any conventional method such as, e.g., the methods described in U.S. Pat. Nos. 5,290,892; 5,693,095; and 5,331,073.

The entire contents and disclosures of each of the above-noted U.S. patents and references are incorporated herein by reference. Unless otherwise stated, all percentages expressed herein are by weight.

1. In a method for modifying the surface of an article, said surface adapted for contact with living tissue of a human or non-human animal, by the gamma- or electron beam-irradiation induced polymerized, chemically grafted coating thereon of a hydrophilic monomer to form a hydrophilic graft polymer coating of the polymerized monomer or mixture of monomers, the improvement comprising conducting the gamma- or electron beam-irradiation induced graft polymerization in an aqueous solution containing a hydrophilic polymer under conditions whereby said hydrophilic polymer is at least partially entrapped in the graft polymerized coating.

2. The method of claim 1 wherein said hydrophilic polymer is a homo-, co-, terpolymer or polymer comprising a polymer backbone that comprises polar heteroatoms (i.e., wherein the polar heteroatoms present within the polymer backbone of the hydrophilic polymers include, but are not limited to, oxygen, nitrogen, sulfur, or phosphorous), selected from the group consisting of polyalkylene oxides, particularly polyethylene glycol, polyethylene oxide, and poly(ethylene oxide)-poly(propylene oxide) copolymers, including block and random copolymers; polyols such as glycerol, polyglycerol (particularly highly branched polyglycerol), propylene glycol and trimethylene glycol substituted with one or more polyalkylene oxides, e.g., mono-, di- and tri-polyoxyethylated glycerol, mono- and di-polyoxyethylated propylene glycol, and mono- and di-polyoxyethylated trimethylene glycol; polyoxyethylated sorbitol, polyoxyethylated glucose; acrylic acid polymers and analogs and copolymers thereof, such as polyacrylic acid per se, polymethacrylic acid, poly(hydroxyethylmethacrylate), poly(hydroxyethylacrylate), poly(methylalkylsulfoxide methacrylate), poly(methylalkylsulfoxide acrylate) and copolymers of any of the foregoing with additional acrylate species such as aminoethyl acrylate and mono-2-(acryloxy)-ethyl succinate; polymaleic acid; poly(acrylamides) such as polyacrylamide per se, poly(methacrylamide), poly(dimethylacrylamide), polydimethylaminoethyl methacrylate, polydimethylaminopropyl methacrylamide, poly(acrylamide/dimethylaminoethyl methacrylate), poly(methacrylic acid/dimethylaminoethyl methacrylate), poly(acrylamide/dimethylaminopropyl methacrylamide), poly(2-acrylamido-2-methyl propane sulfonic acid/dimethylaminoethyl methacrylate), poly (acrylic acid/dimethylaminopropyl methacrylamide), poly(methacrylic acid/dimethylaminopropyl methacrylamide); poly(N-isopropyl-acrylamide); poly(olefinic alcohol)s such as poly(vinyl alcohol); poly(N-vinyl lactams) such as poly(vinyl pyrrolidone), poly(N-vinyl caprolactam), and copolymers thereof; polyoxazolines, including poly(methyloxazoline) and poly(ethyloxazoline); polyvinylamines; polyethylene glycol, polypropylene glycol, branched polyethylene imine, polyvinyl pyrrolidone, polylactide, poly(lactide-co-glycolide), polysorbate, polyethylene oxide, poly(ethylene oxide-co-propylene oxide), poly(oxyethylated) glycerol, poly(oxyethylated) sorbitol, poly(oxyethylated glucose), polymethyloxazoline, polyethyloxazoline, polyhydroxyethyloxazoline, polyhydroxypropyloxazoline, polyvinyl alcohol, poly(hydroxyalkylcarboxylic acid), polyhydroxyethyl acrylic acid, polyhydroxypropyl methacrylic acid, polyhydroxyvalerate, polyhydroxybutyrate, polyoxazolidine, polyaspartamide, polysialic acid, polyalkylene oxide, polyalkyleneimine, polyalkylene amine, polyalkene sulfide, polyalkylene sulfonate, polyalkylene sulfone, poly(alkylenesulfonylalkyleneimine); celluloses; polyamides; polyetheramines; polyethyleneimines; polyhydroxyetheramines; polylysines; polysulfones; gums; starches; cationic starches (formed by reacting a starch, such as corn, maize, waxy maize, potato, tapioca, and the like, with the reaction product of epichlorohydrin and trialkylamine) and derivatives, mixtures and copolymers thereof.

3. The method of claim 1 wherein said hydrophilic monomer is selected from the group consisting of ethylenically unsaturated C₃-C₆ carboxylic acids, such as acrylic acid, alkyl acrylic acids (particularly methacrylic acid), itaconic acid, maleic acid, fumaric acid, acrylamidomethyl-propanesulfonic acid, vinyl sulfonic acid, vinyl phosphonic acid, vinyllactic acid, and styrene sulfonic acid; allylamine and allylamine salts formed with an inorganic acid, e.g., hydrochloric acid; di-C₁-C₃-alkylamino-C₂-C₆-alkyl acrylates and methacrylates such dimethylaminoethyl acrylate, dimethylaminoethyl methacrylate, diethylaminoethyl acrylate, diethylaminoethyl methacrylate, dimethylaminopropyl acrylate, dimethylaminobutyl acrylate, dimethylaminoneopentyl acrylate and dimethylaminoneopentyl methacrylate; olefinically unsaturated nitriles, such as acrylonitrile; diolefinically unsaturated monomers, particularly diallylammonium compounds such as dimethyldiallylammonium chloride, dimethyldiallylammonium bromide, diethyldiallylammonium chloride, methyl-t-butyldiallylammonium methosulfate, methyl-n-propyldiallylammonium chloride, dimethyldiallylammonium hydrogensulfate, dimethyldiallylammonium dihydrogenphosphate, di-n-butyldiallylammonium bromide, diallylpiperidinium bromide, diallylpyrrolidinium chloride and diallylmorpholinium bromide; N-vinylpyrrolidone; N-vinylformamide; acrylamide and substituted acrylamides, such as N-methylolacrylamide and C₁-C₃ alkyl acrylamides, particularly methacrylamide; N-vinylimidazole and N-vinylimidazoline; and other monomers, typically ethylenically unsaturated monomers, preferably vinyl monomers, substituted with at least one hydrophilic functionality such as a carboxylate, a thiocarboxylate, an amide, an imide, a hydrazine, a sulfonate, a sulfoxide, a sulfone, a sulfite, a phosphate, a phosphonate, a phosphonium, an alcohol, a thiol, a nitrate, an amine, an ammonium, or an alkyl ammonium group —[NHR¹R²]⁺, wherein R¹ and R² are alkyl substituents and the group is associated with a negatively charged anion, e.g., a halogen ion, nitrate, etc; carboxymethyl cellulose (CMC), hyaluronic Acid (HA) and mixtures thereof.

4. The method of claim 1 wherein said hydrophilic monomer is part of a mixture thereof with up to about 50 wt. %, based on the total monomer weight, of an ionic monomer, salt of an ionic monomer or a mixture thereof.

5. The article produced by the method of claim 1.

6. The article of claim 4 comprising a contact lens.

7. The contact lens of claim 5 comprising a silicone copolymers, a hydrogel, a RGP, a Disposable Hydrogel Contact Lens or an Extended Wear Contact Lens.

8. An article of manufacture comprising packaging material and an article having a surface adapted for contact with living tissue of a human or non-human animal contained within said packaging material, wherein said surface of said article has been modified to enhance contact with said living tissue, and wherein said packaging material comprises a label which indicates that said article is especially adapted for said contact.

9. The article of manufacture of claim 8 wherein said article having a surface adapted for contact with living tissue of a human or non-human animal is a contact lens.
